(19) United States
(12) Patent Application Publication
(10) Pub. No.: US 2012/0174597 A1
(43) Pub. Date: Jul. 12, 2012

(54) MAGNETIC MATERIALS FOR MAGNETIC REFRIGERATION, MAGNETIC REFRIGERATING DEVICE, AND MAGNETIC REFRIGERATING SYSTEM

(75) Inventors: Shiori Kaji, Kanagawa (JP); Akiko Saito, Kanagawa (JP); Tadahiko Kobayashi, Kanagawa (JP)

(73) Assignee: Kabushiki Kaisha Toshiba, Minato-ku (JP)

(21) Appl. No.: 13/422,373

(22) Filed: Mar. 16, 2012

Related U.S. Application Data
(63) Continuation of application No. PCT/JP2009/005031, filed on Sep. 30, 2009.

(51) Int. Cl. F25B 21/00; H01F 1/06; C22C 28/00; H01F 1/053

(52) U.S. Cl. 62/3.1; 428/611; 420/416

(57) ABSTRACT

A magnetic material for magnetic refrigeration of an embodiment has a composition represented by the formula, Gd_{100-x-y}(HoₓEr_{y}), and satisfies 0<x+y≦25 and 0≦y/(x+y)≦0.6.

### CROSS-REFERENCE TO RELATED APPLICATION

This application is continuation application based upon the International Application PCT/JP2009/005031, the International Filing Date of which is Sep. 30, 2009, the entire content of which is incorporated herein by reference.

### FIELD

Embodiments described herein relate generally to magnetic materials for refrigeration, magnetic refrigerating device, and magnetic refrigerating system.

### BACKGROUND

A magnetic refrigeration is expected as one of the promising environmentally-friendly, high-efficiency refrigeration techniques, and research and development of magnetic refrigeration techniques used in a room temperature range are becoming more and more active. Magnetic refrigeration techniques are based on magnetocaloric effects. The magnetocaloric effect is a temperature change caused in a magnetic substance when an external magnetic field applied to the magnetic substance is adiabatically changed.

As a magnetic refrigerating system used in an ordinary temperature range, an AMR (Active Magnetic Regenerative Refrigeration) type system has been proposed (see U.S. Pat. No. 4,332,135). In the AMR type system, a magnetic refrigeration material not only generates heat but also stores heat. The AMR type system is designed to positively use lattice entropy, which has been regarded as a hindrance to magnetic refrigeration in a room temperature range.

However, the magnetocaloric effect of a magnetic refrigeration material becomes greatest in the vicinity of the magnetic transition temperature, and becomes smaller if temperature deviates from the magnetic transition temperature, resulting in a decrease in work efficiency of the material. In view of this, a technique by which the working temperature range is widened by filling a heat exchange chamber with magnetic materials having different ferromagnetic transition temperatures in a layered manner in accordance with temperature differences occurring inside the heat exchange chamber has been proposed (see JP-A H04-18602 (KOKAI)).

### BRIEF DESCRIPTION OF THE DRAWINGS

FIG. 1 is a graph for explaining functions of a magnetic material for magnetic refrigeration according to a first embodiment.

FIG. 2 is a schematic cross-sectional view of the structure of a magnetic refrigerating device according to a third embodiment.

FIG. 3 is a cross-sectional view showing the structure of magnetic materials inside the heat exchange chamber of the third embodiment.

FIG. 4 is a cross-sectional view showing another structure of magnetic materials inside the heat exchange chamber of the third embodiment.

FIG. 5 is a schematic cross-sectional view of the structure of a magnetic refrigerating system according to a fourth embodiment.

FIG. 6 is a graph showing the temperature dependence of the magnetic entropy variations ΔS of a reference example and an example.

FIG. 7 is a graph showing the relationship between the amount of Gd substitution by Ho and the magnetic transition temperature in each of examples and a comparative example.

FIG. 8 is a graph showing the field dependence of magnetization in each of the reference example and examples.

FIG. 9 is a graph showing the effects of the addition of Er in examples.

### DETAILED DESCRIPTION

A magnetic material for magnetic refrigeration according to one embodiment has a composition represented by the formula, Gd_{100-x-y}(HoₓEr_{y}), and satisfies 0<x+y≦25 and 0≦y/(x+y)≦0.6.

Where materials for magnetic refrigeration are combined for use, the kinds of materials to be combined depend on the component of the apparatus and the target temperature range. Therefore, magnetic materials having various magnetic transition temperatures are required. However, the magnitudes of magnetizations and the magnetic field responses of magnetic materials vary with magnetic transition temperatures, though there exist many magnetic materials having different magnetic transition temperatures. Therefore, in many cases, degradation of characteristics due to decreases in magnetic entropy variation (ΔS) is inevitable.

The inventors have discovered that, when up to 25 at. % of Ho is solid-dissolved in Gd, substantially the same magnetic entropy variation (ΔS) as that of Gd is obtained, though the ferromagnetic transition temperature (hereinafter also represented by T_{C}) becomes lower. The present invention has been completed based on the findings described above.

### First Embodiment

A magnetic material for magnetic refrigeration according to a first embodiment characteristically has a composition represented by the formula, Gd_{100-x-y}(HoₓEr_{y}), and satisfies 0<x+y≦25 and 0≦y/(x+y)≦0.6. Here, 100-x-y, x, and y represent atomic weight ratios. That is, the amount of Gd substitution by Ho and Er is larger than 0 but not larger than 25% in atomic weight ratio. The proportion of Er in the total amount of substitution by Ho and Er is 60% or smaller in atomic weight ratio.

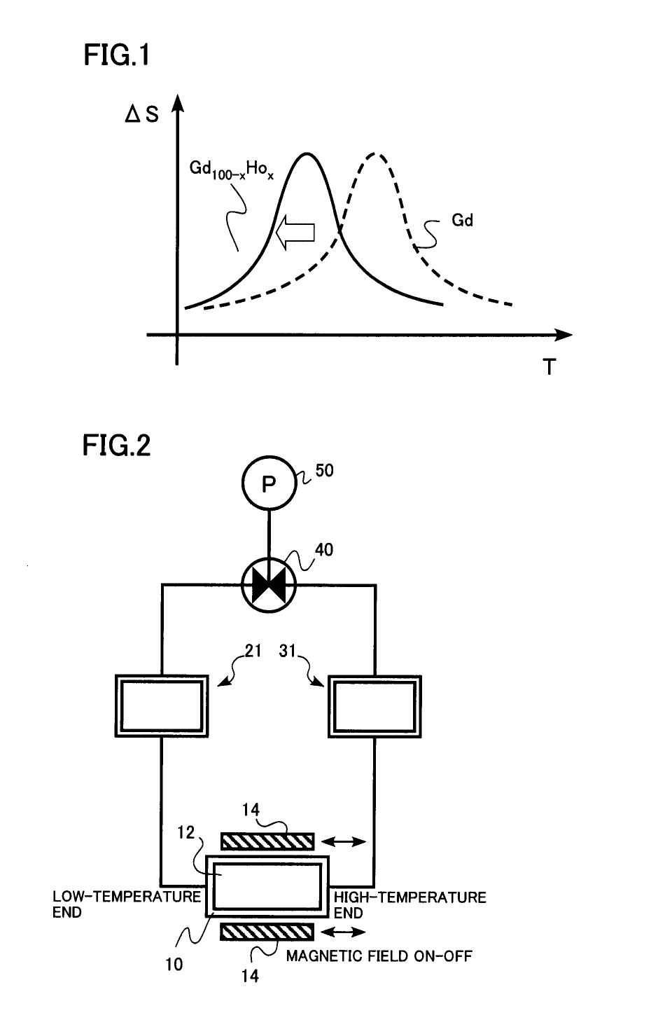

The magnetic material for magnetic refrigeration of this embodiment is a magnetic material in which 25 at. % or less of Ho is solid-dissolved in Gd, for example. FIG. 1 is a graph for explaining functions of the magnetic material for magnetic refrigeration of this embodiment. In the diagram, the abscissa axis indicates temperature (T), and the ordinate axis indicates magnetic entropy variations (ΔS).

Where the ΔS curve (the dotted line) of Gd is compared with the ΔS curve (the solid line) of a case where Ho is added to Gd (Gd₁₀₀₋ₓHoₓ), the ferromagnetic transition temperature can shift to a lower temperature side in the case of (Gd₁₀₀₋ₓHoₓ) than that in the case of the Gd while ΔS is maintained. The shift amount depends on the amount of Ho added. Therefore, with the magnetic material for magnetic refrigeration, a desired magnetic refrigeration operating temperature that differs from that of the Gd can be realized by adjusting the amount of Ho to be added, while a magnetic entropy variation is not degraded.

It should be noted that the atomic weight ratio of Ho in the magnetic material is 0 (at. %)<x≦25 (at. %), because, when the atomic weight ratio of Ho becomes higher than 25 at. %, the ferromagnetic transition temperature shifts to the low-temperature side but the decrease of ΔS is larger than that in the case of the Gd.

In this embodiment, the magnetic material is preferably not a binary material of Gd and Ho but a ternary material having Er added thereto. This is because, by adding Er, the magnetic field response can be improved while substantially the same ΔS as that of the Gd is maintained. It is considered that, with this structure, the magnetic flux flow into a magnetic refrigeration material can be accelerated, and the efficiency of magnetic refrigerating operations can be made higher.

The following are possible reasons that the magnetic field response can be made higher by forming a ternary material containing Er while substantially the same ΔS as that of the Gd is maintained. Except for Gd, any rare earth element containing Ho has large magnetic anisotropy. Therefore, where a rare earth element is added to Gd, the magnetic transition temperature becomes lower, but the magnetic field response becomes poorer especially in a low magnetic field. As a result, ΔS tends to become smaller. In a case where Ho is added to Gd, the magnetic field response becomes poorer, but the magnetization increased by the Ho addition contributes to a larger increase of ΔS than that in the case of the Gd. It should be noted that the magnetic field response of a magnetic material is evaluated according to the magnetic field dependence of the magnetization.

Er has a magnetic anisotropy constant with the reversed sign of that of Ho. Therefore, by adding Ho and Er to Gd at the same time, the magnetic anisotropy influence can be cancelled, and degradation of the magnetic field response can be restrained. Accordingly, the contribution of the increase in magnetization by Ho becomes larger, and the magnetic field response can be improved while substantially the same ΔS as that of the Gd is maintained.

In the case where the magnetic material has a composition represented by the formula, Gd_{100-x-y}(HoₓEr_{y}), and Er to be added needs to satisfy 0<x+y≦25 and 0≦y/(x+y)≦0.6. The atomic weight ratio of Ho and Er in the magnetic material is 0 (at. %)<x+y≦25 (at. %), because, when the atomic weight ratio of Ho and Er becomes higher than 25 at. %, the ferromagnetic transition temperature shifts to the low-temperature side but the decrease of ΔS is larger than that in the case of the Gd. Also, when the proportion of Er exceeds 60% in atomic weight ratio, the effect of the Er addition to increase the magnetic field response is lost.

In this embodiment, the magnetic material for magnetic refrigeration is preferably particles with substantially spherical shapes. Further, the maximum particle size is preferably not smaller than 0.3 mm and not larger than 2 mm. The maximum particle size can be evaluated by visual measurement with a caliper, or by measurement through direct observations under a microscope or through photomicrograph. To realize a high refrigeration capacity with a magnetic refrigerating device using liquid refrigerant, it is important to have a sufficient heat exchange performed between the magnetic material and the liquid refrigerant packed in a heat exchange chamber, and realize high heat exchange efficiency.

It is also necessary to secure the flow path for the liquid refrigerant while maintaining the high filling rate of the magnetic material so that a sufficient heat exchange is performed between the magnetic material and the liquid refrigerant. To do so, the magnetic material for magnetic refrigeration preferably has substantially sphere shapes. Also, it is preferable to reduce the particle sizes to increase the specific surface areas of the particles. However, if the particle sizes are too small, the pressure loss of the refrigerant increases. Therefore, to reduce the pressure loss and maintain preferable heat exchange efficiency, the particles of this embodiment preferably have a maximum size that is not smaller than 0.3 mm and not larger than 2 mm.

### Second Embodiment

A magnetic material for magnetic refrigeration according to a second embodiment is characterized by the compositional formula, Gd_{100-x-z}(HoₓY_{z}), and 0<x, 0<x+z≦15 and 0<z≦1.0. Here, 100-x-z, x, and z represent atomic weight ratios.

In this embodiment, the magnetic material is a ternary magnetic material containing a small amount of Y added to Gd and Ho. Even where a small amount of Y is added, the ferromagnetic transition temperature can shift to the low-temperature side while ΔS is maintained, as in the case of a binary material of Gd and Ho.

### Third Embodiment

A magnetic refrigerating device according to a third embodiment is a magnetic refrigerating device of the AMR type using liquid refrigerant. The magnetic refrigerating device includes a heat exchange chamber filled with a magnetic material, a magnetic field generator that applies and removes a magnetic field to and from the magnetic material, a low-temperature-side heat exchange unit that is connected to the low-temperature end of the heat exchange chamber and has cold transferred from the heat exchange chamber, and a high-temperature-side heat exchange unit that is connected to the high-temperature end of the heat exchange chamber and has heat transferred from the heat exchange chamber. The magnetic refrigerating device further includes a pipe that connects the low-temperature-side heat exchange unit and the high-temperature-side heat exchange unit. That is, the magnetic refrigerating device includes a refrigerant circuit that is formed by connecting the heat exchange chamber, the low-temperature-side heat exchange unit, and the high-temperature-side heat exchange unit, and circulates liquid refrigerant. The magnetic material packed in the heat exchange chamber is characterized by being the magnetic material for magnetic refrigeration of the first or second embodiment. Explanation of the same aspects of the magnetic material as those of the first or second embodiment is omitted therein.

FIG. 2 is a schematic cross-sectional view of the structure of the magnetic refrigerating device of this embodiment. This magnetic refrigerating device uses water as the liquid refrigerant, for example. A low-temperature-side heat exchange unit 21 is provided at the low-temperature end of the heat exchange chamber 10, and a high-temperature-side heat exchange unit 31 is provided at the high-temperature end of the heat exchange chamber 10. A switcher 40 for switching refrigerant flowing directions is provided between the low-temperature-side heat exchange unit 21 and the high-temperature-side heat exchange unit 31. Further, a refrigerant pump 50 serving as a refrigerant transporting means is connected to the switcher 40. The heat exchange chamber 10, the low-temperature-side heat exchange unit 21, the switcher 40, and the high-temperature-side heat exchange unit 31 are connected by pipes, and form a refrigerant circuit that circulates the liquid refrigerant.

The heat exchange chamber 10 is filled with a magnetic material 12 of the first embodiment having a magnetocaloric effect. Permanent magnets 14 that can move in a horizontal direction are provided as a magnetic field generator outside the heat exchange chamber 10.

Referring now to FIG. 2, operations of the magnetic refrigerating device of this embodiment are briefly described. When the permanent magnets 14 are placed in positions (the positions indicated in FIG. 2) facing the heat exchange chamber 10, a magnetic field is applied to the magnetic material 12 inside the heat exchange chamber 10. As a result, the magnetic material 12 having a magnetocaloric effect generates heat. At this point, the refrigerant pump 50 and the switcher 40 operate to circulate the liquid refrigerant in a direction from the heat exchange chamber 10 to the high-temperature-side heat exchange unit 31. The temperature of the liquid refrigerant becomes warm because of the heat generation from the magnetic material 12, and the liquid refrigerant transfers heat to the high-temperature-side heat exchange unit 31.

After that, the permanent magnets 14 are moved from the positions facing the heat exchange chamber 10, to remove the magnetic field from the magnetic material 12. By removing the magnetic field, the magnetic material 12 absorbs heat. At this point, the refrigerant pump 50 and the switcher 40 operate to circulate the liquid refrigerant in a direction from the heat exchange chamber 10 to the low-temperature-side heat exchange unit 21. The temperature of the liquid refrigerant becomes cool because of the heat absorption by the magnetic material 12, and the liquid refrigerant transfers cold to the low-temperature-side heat exchange unit 21.

The moving of the permanent magnets 14 is repeated, and the application and removal of the magnetic field to and from the magnetic material 12 inside the heat exchange chamber 10 are repeated, so that a temperature gradient occurs in the magnetic material 12 inside the heat exchange chamber 10. The cooling of the low-temperature-side heat exchange unit 21 is continued by the movement of the liquid refrigerant synchronized with the application and removal of the magnetic field.

By using the magnetic material for magnetic refrigeration having a wider range of magnetic refrigeration operating temperatures, the magnetic refrigerating device of this embodiment can realize high heat exchange efficiency.

In this embodiment, the magnetic material 12 inside the heat exchange chamber 10 may not be one magnetic material that has one composition and is evenly packed in the heat exchange chamber 10, but may be two or more magnetic materials that have different compositions and are packed in the heat exchange chamber 10.

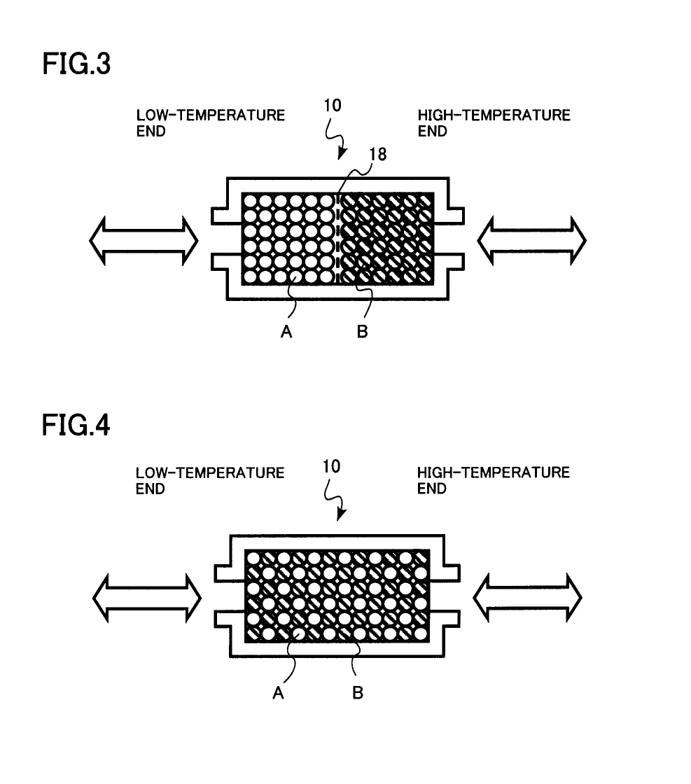

For example, the magnetic material may contain the magnetic material for magnetic refrigeration according to the first embodiment and a magnetic material having at least another composition, and the magnetic material for magnetic refrigeration and the magnetic material having the other composition are preferably packed as layers in the heat exchange chamber. FIG. 3 is a cross-sectional view showing the structure of magnetic materials inside the heat exchange chamber of this embodiment.

As shown in FIG. 3, the low-temperature side of the heat exchange chamber 10 is filled with magnetic particles A of an alloy containing Gd and Ho according to the first embodiment, for example. The high-temperature side is filled with magnetic particles B such as magnetic particles of the Gd having a higher ferromagnetic transition temperature than that of the magnetic particles A. The magnetic material on the low-temperature side and the magnetic material on the high-temperature side are partitioned by a grid-like partition wall 18 through which the refrigerant can pass, so as not to mix with each other. The magnetic materials are packed as layers. At both ends of the heat exchange chamber 10, openings are formed to allow the refrigerant to flow to the left and right in the heat exchange chamber 10.

Where the magnetic materials arranged in the heat exchange chamber as shown in FIG. 3 are used, the magnetic refrigeration operating temperature range becomes even wider, and a magnetic refrigerating device that realizes even higher heat exchange efficiency can be provided. Although the magnetic materials inside the heat exchange chamber form a two-layer stack structure in FIG. 3, a stack structure of three or more layers may be used to further widen the magnetic refrigeration operating temperature range and realize even higher heat exchange efficiency.

Alternatively, the magnetic material may contain the magnetic material for magnetic refrigeration according to the first or second embodiment and at least another magnetic material having a different composition, and the magnetic material for magnetic refrigeration and the magnetic material having the different composition are preferably mixed and packed in the heat exchange chamber. FIG. 4 is a cross-sectional view showing another structure of magnetic materials inside the heat exchange chamber.

As shown in FIG. 4, the heat exchange chamber 10 is filled, in a mixed manner, with magnetic particles A of an alloy containing Gd and Ho according to the first embodiment, and magnetic particles B such as magnetic particles of the Gd having a higher (lower) ferromagnetic transition temperature than that of the magnetic particles A.

Where the magnetic materials arranged in the heat exchange chamber as shown in FIG. 4 are used, the magnetic refrigeration operating temperature range becomes even wider, and a magnetic refrigerating device that realizes even higher heat exchange efficiency can be provided. Although the particles of two kinds of magnetic materials are mixed in the heat exchange chamber in FIG. 4, three or more kinds of magnetic materials may be mixed to further widen the magnetic refrigeration operating temperature range and realize even higher heat exchange efficiency.

### Fourth Embodiment

A magnetic refrigerating system according to a fourth embodiment characteristically includes the magnetic refrigerating device according to the third embodiment, a cooling unit thermally connected to the low-temperature-side heat exchange unit, and a heat exhausting unit thermally connected to the high-temperature-side heat exchange unit. In the following, explanation of the same aspects as those described in the third embodiment is omitted.

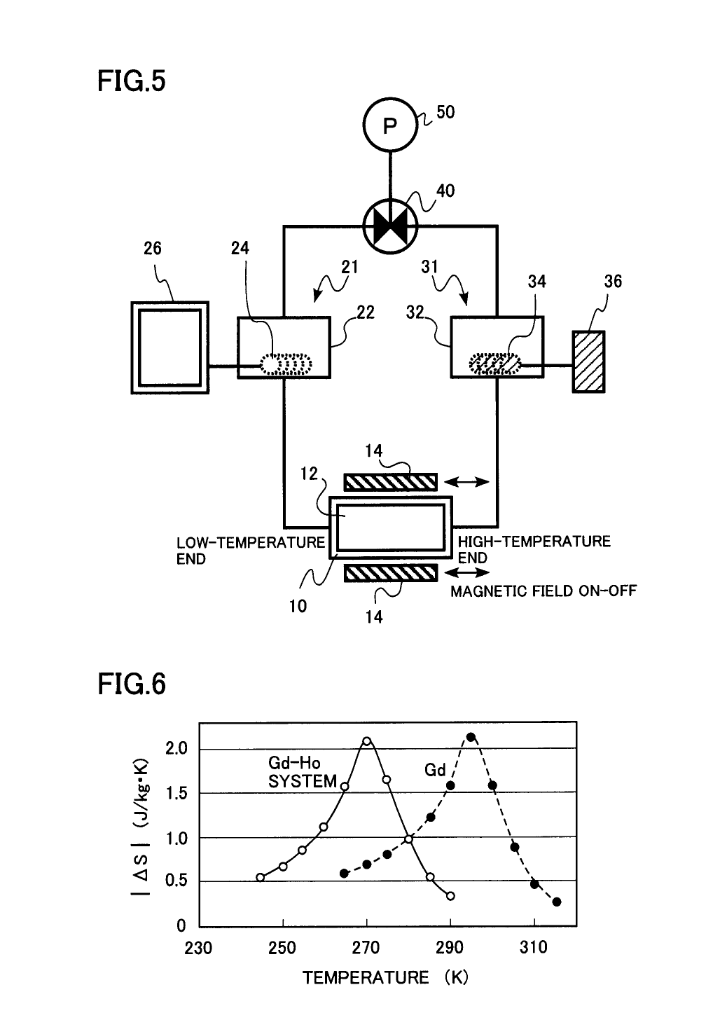

FIG. 5 is a schematic cross-sectional view of the structure of the magnetic refrigerating system of this embodiment. This magnetic refrigerating system includes a cooling unit 26 thermally connected to the low-temperature-side heat exchange unit 21 and a heat exhausting unit 36 thermally connected to the high-temperature-side heat exchange unit 31, in addition the magnetic refrigerating device of FIG. 2.

The low-temperature-side heat exchange unit 21 is formed by a low-temperature-side water storage tank 22 that stores low-temperature refrigerant, and a low-temperature-side heat exchanger 24 that is provided in the low-temperature-side water storage tank 22 and is in contact with the refrigerant. Likewise, the high-temperature-side heat exchange unit 31 is formed by a high-temperature-side water storage tank 32 that stores high-temperature refrigerant, and a high-temperature-side heat exchanger 34 that is provided in the high-temperature-side water storage tank 32 and is in contact with the refrigerant. The cooling unit 26 is thermally connected to the low-temperature-side heat exchanger 24, and the heat exhausting unit 36 is thermally connected to the high-temperature-side heat exchanger 34.

This magnetic refrigerating system can be applied to a household refrigerator, for example. In this case, the cooling unit 26 is a freezer/refrigerator section to be cooled, and the heat exhausting unit 36 is a heatsink, for example.

It should be noted that this magnetic refrigerating system is not particularly limited. Other than the above described household freezer/refrigerator, the magnetic refrigerating system can be applied to refrigerating systems such as household freezers/refrigerators, household air conditioners, industrial freezers/refrigerators, large-scale freezers/refrigerators, and liquefied gas storage/transportation freezers. Those apparatuses have different necessary refrigeration capacities and different temperature control ranges, depending on places of use. However, refrigeration capacities can be changed by adjusting the amount of magnetic particles to be used. Further, since the magnetic transition temperature can be changed by controlling the materials of magnetic particles, the temperature control range can be adjusted to a specific temperature range. Furthermore, the magnetic refrigerating system can also be applied to air conditioning systems such as household air conditioners and industrial air conditioners that use the heat exhausted from magnetic refrigerating devices in heating. The magnetic refrigerating system may also be applied to plants using both refrigeration and heat generation.

The magnetic refrigerating system of this embodiment can realize a magnetic refrigerating system that improves the magnetic refrigeration efficiency.

While certain embodiments have been described, these embodiments have been presented by way of example only, and are not intended to limit the scope of the inventions. Indeed, the magnetic materials for magnetic refrigeration, the magnetic refrigerating device, and the magnetic refrigerating system described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

The following is a detailed description of examples.

### EXAMPLE 1

A magnetic material having a composition represented by the formula, Gd₉₅Ho₅, was formed. After the material having the above composition is adjusted, this magnetic material is alloyed by arc melting. At this point, several reversals are performed, and melting is repeated, so as to increase uniformity.

Magnetization measurement was carried out on the produced magnetic material with the same shapes and field applying directions, to determine the magnetic entropy variation (ΔS(T,ΔHₑₓₜ)). The following mathematical formula was used in calculating ΔS.

$$Δ S ( T , Δ {H}_{ext} ) = {\int }_{0}^{{H}_{ext}} \frac{\partial M}{\partial T} d {H}_{ext}$$

Here, T represents temperature, Hₑₓₜ represents the applied external magnetic field, and M represents magnetization. In this example, the applied external magnetic field Hₑₓₜ in magnetization measurement was varied from 0 to approximately 4×10⁵ A/m (5 kOe). That is, the magnetic field variation ΔHₑₓₜ is approximately 4×10⁵ A/m. Temperature was measured from 220 K to 315 K.

The maximum value of ΔS was ΔSₘₐₓ. The results are shown in Table 1.

### EXAMPLE 2

Except for having a composition represented by the formula, Gd₉₀Ho₁₀, a magnetic material was formed and evaluated in the same manner as in Example 1. The results are shown in Table 1. The magnetic field response was also evaluated. Here, the magnetic field response is represented by the value of magnetization where Hₑₓₜ=1 kOe.

### EXAMPLE 3

Except for having a composition represented by the formula, Gd₈₈Ho₁₂, a magnetic material was formed and evaluated in the same manner as in Example 1. The results are shown in Table 1.

### EXAMPLE 4

Except for having a composition represented by the formula, Gd₈₅Ho₁₅, a magnetic material was formed and evaluated in the same manner as in Example 1. The results are shown in Table 1. The magnetic field response was also evaluated. Here, the magnetic field response is represented by the value of magnetization where Hₑₓₜ=1 kOe.

### EXAMPLE 5

Except for having a composition represented by the formula, Gd₇₅Ho₂₅, a magnetic material was formed and evaluated in the same manner as in Example 1. The results are shown in Table 1.

### COMPARATIVE EXAMPLE 1

Except for having a composition represented by the formula, Gd₆₀Ho₄₀, a magnetic material was formed and evaluated in the same manner as in Example 1. The results are shown in Table 1.

### REFERENCE EXAMPLE

Except for the Gd, a magnetic material was formed and evaluated in the same manner as in Example 1. The results are shown in Table 1 and Table 2.

### COMPARATIVE EXAMPLE 2

Except for having a composition represented by the formula, Gd₉₅Er₅, a magnetic material was formed and evaluated in the same manner as in Example 1. The results are shown in Table 2.

### COMPARATIVE EXAMPLE 3

Except for having a composition represented by the formula, Gd₉₀Er₁₀, a magnetic material was formed and evaluated in the same manner as in Example 1. The results are shown in Table 2.

### COMPARATIVE EXAMPLE 4

Except for having a composition represented by the formula, Gd₈₅Er₁₅, a magnetic material was formed and evaluated in the same manner as in Example 1. The results are shown in Table 2.

### COMPARATIVE EXAMPLE 5

Except for having a composition represented by the formula, Gd₇₀Tb₃₀, a magnetic material was formed and evaluated in the same manner as in Example 1. The results are shown in Table 2.

### COMPARATIVE EXAMPLE 6

Except for having a composition represented by the formula, Gd₅₀Tb₅₀, a magnetic material was formed and evaluated in the same manner as in Example 1. The results are shown in Table 2.

### EXAMPLE 6

Except for having a composition represented by the formula, Gd₉₀(Ho₈Er₂), a magnetic material was formed and evaluated in the same manner as in Example 1. The magnetic field response was also evaluated. As the index of the magnetic field response, the ratio to the magnetic field response, M/M₀, M₀ is M of Example 2 having the same amount of Gd substitution but not containing Er was used. The results are shown in Table 3.

### EXAMPLE 7

Except for having a composition represented by the formula, Gd₉₀(Ho₆Er₄), a magnetic material was formed and evaluated in the same manner as in Example 1. The magnetic field response was also evaluated. As the index of the magnetic field response, the ratio to the magnetic field response, M/M₀, M₀ is M of Example 2 having the same amount of Gd substitution but not containing Er was used. The results are shown in Table 3.

### EXAMPLE 8

Except for having a composition represented by the formula, Gd₉₀(Ho₄Er₆), a magnetic material was formed and evaluated in the same manner as in Example 1. The magnetic field response was also evaluated. As the index of the magnetic field response, the ratio to the magnetic field response, M/M₀, M₀ is M of Example 2 having the same amount of Gd substitution but not containing Er was used. The results are shown in Table 3.

### EXAMPLE 9

Except for having a composition represented by the formula, Gd₈₅(Ho₁₂Er₃), a magnetic material was formed and evaluated in the same manner as in Example 1. The magnetic field response was also evaluated. As the index of the magnetic field response, the ratio to the magnetic field response, M/M₀, M₀ is M of Example 4 having the same amount of Gd substitution but not containing Er was used. The results are shown in Table 3.

### EXAMPLE 10

Except for having a composition represented by the formula, Gd₈₅(Ho₇Er₈), a magnetic material was formed and evaluated in the same manner as in Example 1. The magnetic field response was also evaluated. As the index of the magnetic field response, the ratio to the magnetic field response, M/M₀, M₀ is M of Example 4 having the same amount of Gd substitution but not containing Er was used. The results are shown in Table 3.

### EXAMPLE 11

Except for having a composition represented by the formula, Gd₈₅(Ho₁₄Yo₁), a magnetic material was formed and evaluated in the same manner as in Example 1. The results are shown in Table 4.

### EXAMPLE 12

Except for having a composition represented by the formula, Gd₈₅(Ho_{13.5}Yo_{1.5}), a magnetic material was formed and evaluated in the same manner as in Example 1. The results are shown in Table 4.

TABLE 1

| | | Magnetic | |
|---|---|---|---|
| | | transition | ΔSₘₐₓ |
| | | temperature (K) | (ΔHₑₓₜ = 5 kOe) |
| Reference | Gd | 294 | 2.1 |
| Example | | | |
| Example 1 | Gd₉₅Ho₅ | 287.1 | 2.1 |
| Example 2 | Gd₉₀Ho₁₀ | 278.3 | 2.1 |
| Example 3 | Gd₈₈Ho₁₂ | 276.3 | 2.1 |
| Example 4 | Gd₈₅Ho₁₅ | 270.5 | 2.1 |
| Example 5 | Gd₇₅Ho₂₅ | 253.5 | 2.0 |
| Comparative | Gd₆₀Ho₄₀ | 223.1 | 1.9 |
| Example 1 | | | |

TABLE 2

| | | Magnetic | |
|---|---|---|---|
| | | transition | ΔSₘₐₓ |
| | | temperature (K) | (ΔHₑₓₜ = 5 kOe) |
| Reference | Gd | 294 | 2.1 |
| Example | | | |
| Comparative | Gd₉₅Er₅ | 285.7 | 1.9 |
| Example 2 | | | |
| Comparative | Gd₉₀Er₁₀ | 275.5 | 1.9 |
| Example 3 | | | |
| Comparative | Gd₈₅Er₁₅ | 265 | 1.9 |
| Example 4 | | | |
| Comparative | Gd₇₀Tb₃₀ | 274.1 | 1.8 |
| Example 5 | | | |
| Comparative | Gd₅₀Tb₅₀ | 262 | 1.8 |
| Example 6 | | | |

TABLE 3

| | | Atomic weight | | | |
|---|---|---|---|---|---|
| | | ratio (%) of Er | | | |
| | | to total amount | ΔSₘₐₓ | | |
| | | of substitution | (ΔHₑₓₜ = 5 kOe) | | |
| | | | | M/M₀ | M/M₀ |
| | | | | (Example 2) | (Example 2) |
| | | | | (1 kOe, 10 K) | (1 kOe, 253 K) |
| Example 2 | Gd₉₀Ho₁₀ | 0 | 2.1 | 1 | 1 |
| Example 6 | Gd₉₀(Ho₈Er₂) | 20 | 2.0 | 1.31 | 1.04 |
| Example 7 | Gd₉₀(Ho₆Er₄) | 40 | 2.0 | 1.27 | 1.02 |
| Example 8 | Gd₉₀(Ho₄Er₆) | 60 | 2.0 | 1.26 | 1.01 |
| | | | | M/M₀ | M/M₀ |
| | | | | (Example 4) | (Example 4) |
| | | | | (1 kOe, 10 K) | (1 kOe, 248 K) |
| Example 4 | Gd₈₅Ho₁₅ | 0 | 2.1 | 1 | 1 |
| Example 9 | Gd₈₅(Ho₁₂Er₃) | 20 | 2.1 | 1.28 | 1.03 |
| Example 10 | Gd₈₅(Ho₇Er₈) | 53 | 2.0 | 1.47 | 1.03 |

TABLE 4

| | | ΔSₘₐₓ |
|---|---|---|
| | | (ΔHₑₓₜ = 5 kOe) |
| Example 4 | Gd₈₅Ho₁₅ | 2.1 |
| Example 11 | Gd₈₅Ho₁₄Y₁ | 2.1 |
| Example 12 | Gd₈₅Ho_{13.5}Y_{1.5} | 2.0 |

FIG. 6 is a graph showing the temperature dependence of the magnetic entropy variations (|ΔS|) of Reference Example and Example 4. As can be seen from the graph, Example 4 having Ho added shifts to the low-temperature side while maintaining the same ΔSₘₐₓ as that of Reference Example.

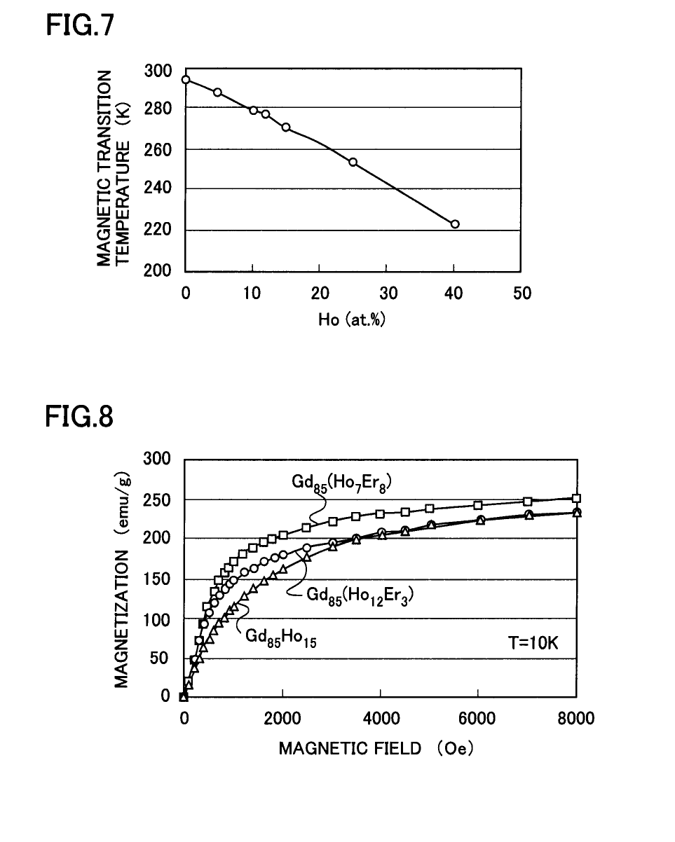

FIG. 7 is a graph showing the relationship between the amount of Gd substitution by Ho and the magnetic transition temperature. As shown in the graph, the magnetic transition temperature moves toward the low-temperature side, as the amount of Gd substitution by Ho is increased. At this point, ΔSₘₐₓ becomes substantially the same as that in the case of the Gd, as is apparent from Table 1. That is, a magnetic entropy variation equal to or larger than a predetermined variation can be realized at a lower temperature than that in the case of the Gd.

FIG. 8 is a graph showing the field dependence of magnetization. As shown in FIG. 8, where Er is added to a Gd—Ho material, a large magnetization change can be achieved especially in a low magnetic field. That is, the magnetic field response of a magnetic material is improved especially in a low magnetic field.

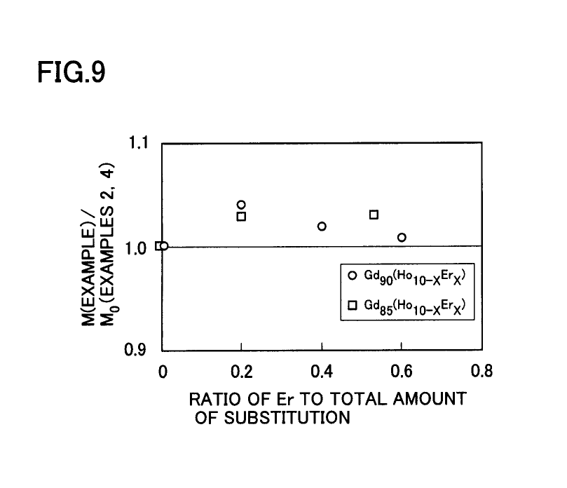

FIG. 9 is a graph showing the effect of the addition of Er. The graph shows the dependence of M/M₀ in the neighborhood of 250 K on the atomic weight ratio of Er to the total amount of Gd substitution. By adding Er, a higher magnetic field response than that in the case where Er is not added is achieved, and the atomic weight ratio of Er to the total amount of substitution is maintained up to approximately 60%.

What is claimed is:

1. A magnetic material for magnetic refrigeration having a composition represented by the formula, Gd_{100-x-y}(HoₓEr_{y}), the magnetic material for magnetic refrigeration satisfying 0<x+y≦25 and 0≦y/(x+y)≦0.6.

2. The material according to claim 1, wherein the magnetic material for magnetic refrigeration is particles each having a substantially spherical shape, and a maximum size of the particles is not smaller than 0.3 mm and not larger than 2 mm.

3. A magnetic material for magnetic refrigeration having a composition represented by the formula, Gd_{100-x-z}(HoₓY_{z}), the magnetic material for magnetic refrigeration satisfying 0<x, 0<x+z≦15, and 0<z≦1.0.

4. The material according to claim 3, wherein the magnetic material for magnetic refrigeration is particles each having a substantially spherical shape, and a maximum size of the particles is not smaller than 0.3 mm and not larger than 2 mm.

5. A magnetic refrigerating device using liquid refrigerant, comprising:
a heat exchange chamber filled with a magnetic material;
a magnetic field generator that applies and removes a magnetic field to and from the magnetic material;
a low-temperature-side heat exchange unit that is connected to a low-temperature end of the heat exchange chamber, and cold is transferred from the heat exchange chamber to the low-temperature-side heat exchange unit;
a high-temperature-side heat exchange unit that is connected to a high-temperature end of the heat exchange chamber, and heat is transferred from the heat exchange chamber to the high-temperature-side heat exchange unit; and
a pipe that connects the low-temperature-side heat exchange unit and the high-temperature-side heat exchange unit,
wherein at least part of the magnetic material is the magnetic material for magnetic refrigeration having a composition represented by the formula, Gd_{100-x-y}(HoₓEr_{y}), the magnetic material for magnetic refrigeration satisfying 0<x+y≦25 and 0≦y/(x+y)≦0.6.

6. The device according to claim 5, wherein the magnetic material for magnetic refrigeration is particles each having a substantially spherical shape, and a maximum size of the particles is not smaller than 0.3 mm and not larger than 2 mm.

7. A magnetic refrigerating system comprising:
a heat exchange chamber filled with a magnetic material;
a magnetic field generator that applies and removes a magnetic field to and from the magnetic material;
a low-temperature-side heat exchange unit that is connected to a low-temperature end of the heat exchange chamber, and cold is transferred from the heat exchange chamber to the low-temperature-side heat exchange unit;
a high-temperature-side heat exchange unit that is connected to a high-temperature end of the heat exchange chamber, and heat is transferred from the heat exchange chamber to the high-temperature-side heat exchange unit; and
a pipe that connects the low-temperature-side heat exchange unit and the high-temperature-side heat exchange unit,
a cooling unit thermally connected to the low-temperature-side heat exchange unit; and
a heat exhausting unit thermally connected to the high-temperature-side heat exchange unit,
wherein at least part of the magnetic material is the magnetic material for magnetic refrigeration having a composition represented by the formula, Gd_{100-x-y}(HoₓEr_{y}), the magnetic material for magnetic refrigeration satisfying 0<x+y≦25 and 0≦y/(x+y)≦0.6.

8. The system according to claim 7, wherein the magnetic material for magnetic refrigeration is particles each having a substantially spherical shape, and a maximum size of the particles is not smaller than 0.3 mm and not larger than 2 mm.
